(19) United States
(12) Patent Application Publication
(10) Pub. No.: US 2008/0320429 A1
(43) Pub. Date: Dec. 25, 2008

(54) CIRCUIT LAYOUT TOOL DIMMING FEATURE

(75) Inventors: Blaine J. Gross, Essex Junction, VT (US); Karl L. Ladin, Rochester, MN (US); Thomas C. Perez, Rochester, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/766,415

(22) Filed: Jun. 21, 2007

(51) Int. Cl. G06F 17/50

(52) U.S. Cl. 716/11

(57) ABSTRACT

A computer program product stored on machine readable media including machine executable instructions for display a layout of a circuit design, includes instructions for: receiving designation of at least one design segment from a user; receiving designation of a degree of intensity for at least one of highlighting and dimming the design segments and on a display screen, highlighting the designated design segments and dimming remaining segments on the display. A system is also provided.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to circuit design layout editors, and particularly to distinguishing features within a design layout.

2. Description of the Related Art

A circuit or layout designer often uses layout editors to edit the circuits they own or for which they are responsible. Layouts can easily get confusing to view and it is very hard to distinguish which sections of the layout belong to certain levels of hierarchy. The designer will often spend a lot of time tracing known paths of the layout to find the area of the layout they wish to analyze or edit.

What are needed are features that provide additional functionality to the layout editor. The features should enable a designer to more quickly define what areas of the layout belong to a particular level or hierarchy. Preferably, the features provide other benefits, such as highlighting portions of interest.

### SUMMARY OF THE INVENTION

The shortcomings of the prior art are overcome and additional advantages are provided through the provision of a computer program product stored on machine readable media including machine executable instructions for display a layout of a circuit design, the product including instructions for: receiving designation of a design segment from a user; and on a display screen, highlighting the designated design segment and dimming remaining segments on the display.

Also disclosed is a system for editing a layout of a circuit, the system including: processing, display, storage, input and output resources for executing machine readable instructions stored in the storage; and a computer program product stored on the storage and including machine executable instructions for display of the layout, the product including instructions for receiving designation of a design segment from a user; and on a display screen, receiving designation of a degree of intensity for at least one of highlighting and dimming a display of design segments; and highlighting the designated design segment and dimming remaining segments on the display.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

Technically, a simpler user interface having better usability is provided. That is, as a result of the summarized invention, technically we have achieved a solution which a computer program product stored on machine readable media and including machine executable instructions for incorporation into a layout editor for layout of a circuit design is provided. The product includes instructions for display of the layout of the circuit design, the product including instructions for: receiving designation of a design segment including at least one of an area of interest, a layer, an element, a feature, a routine, a method, an object, a region, a component and a sub-component from a user; and on a display screen, highlighting the designated design segment by increasing an intensity of an appearance of the designated design segment; and dimming remaining segments on the display by substantially reducing intensity of the appearance of the remaining segments.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts an infrastructure for operation of a layout editor; and

FIG. 2 depicts an exemplary display of the layout editor according to the teachings herein.

The detailed description explains the preferred embodiments of the invention, together with advantages and features, by way of example with reference to the drawings.

### DETAILED DESCRIPTION OF THE INVENTION

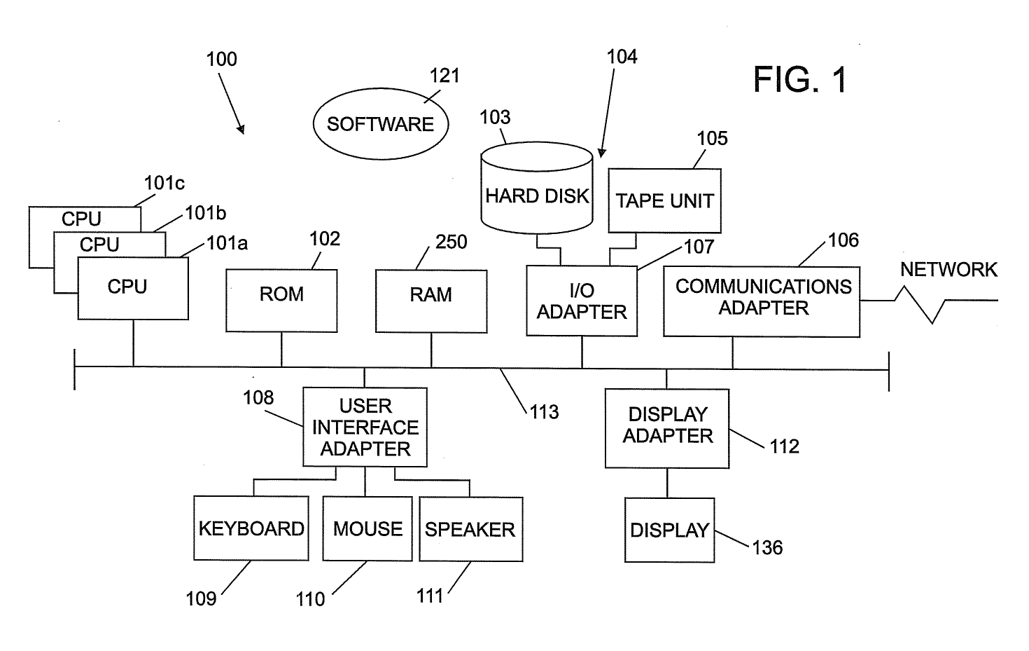

Referring to FIG. 1, there is shown an embodiment of a processing system 100 for implementing the teachings herein is depicted. System 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 250 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 120 enabling data processing system 100 to communicate with other such systems. Display monitor 136 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

As disclosed herein, the system 100 includes machine readable instructions stored on machine readable media (for example, the hard disk 104) for layout and editing of a circuit design. As referred to herein, the instructions are referred to as design layout software 121. The software 121 may be produced using software development tools as are known in the art. As discussed herein, the software 121 is also referred to as a “layout editor” 121 or simply as an “editor” 121. The layout editor 121 may include various editing tools and layout features as are known in the art.

The layout editor 121 permits a designer to focus on a particular aspect of a circuit layout, or a layout of a similar nature. As used herein, these aspects are generally referred to as “segments” of a layout. Exemplary segments may include areas of interest, layers, elements, features, routines, methods, objects, regions, components, sub-components and other such divisions of a work product.

The editor 121 provides a level of hierarchy by using a dimming (or brightness) function. The dimming function provides for highlighting at least one certain segment of work. This may be accomplished by brightening (increasing the intensity) of the area of interest. In addition, the dimming function provides for dimming (reducing the intensity) of all other segments within the layout. Accordingly, a designer using the dimming function can quickly distinguish between the various segments within the layout.

In some embodiments, the software 121 provides a dimming function as an overlay to another program providing for layout editing. For example, the software 121 may be provided as an “add-in” to an application (where “add-in” is taken to mean supplemental program code as is known in the art). In such embodiments, the software 121 replaces structures of the application for highlighting layout segments described herein.

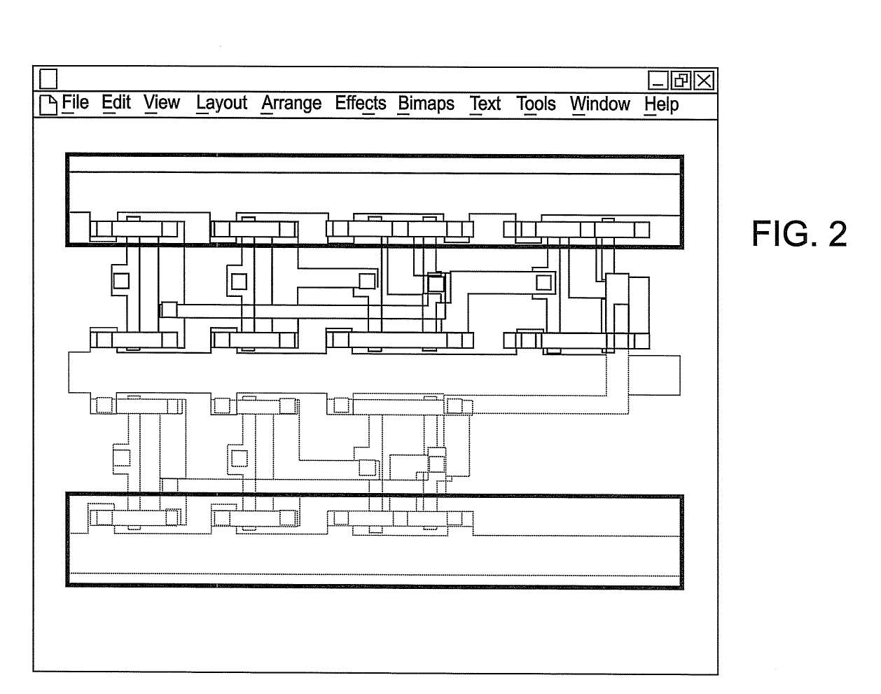

FIG. 2 provides an exemplary user screen having information emphasis according to the dimming function disclosed herein. As shown in FIG. 2, certain aspects of the layout (e.g., a circuit component) may be highlighted as a segment of interest.

In some embodiments, the highlighting (or dimming) is only with regard to intensity of each segment. In other embodiments, the highlighting or dimming includes other techniques for differentiation of segments (such as, color, patterns and other such screen based techniques for differentiation). A degree of highlighting or dimming may be controlled by the user. That is, the software 121 may receive input from the user for a desired intensity level for designated segments.

Dimming may include reduction of intensity of the appearance for a segment to an extent that appearance of the segment may appear to have been turned off completely, or substantially reduced such that the segment is barely discernable.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer program product stored on machine readable media and comprising machine executable instructions for displaying a layout of a circuit design, the product comprising instructions for:
receiving designation of at least one design segment from a user;
on a display screen, highlighting the designated design segments and
dimming remaining segments on the display.

2. The computer program product as in claim 1, farther comprising receiving designation of a degree of intensity for at least one of the highlighting and the dimming.

3. The computer program product as in claim 1, wherein the design segment comprises at least one of an area of interest, a layer, an element, a feature, a routine, a method, an object, a region, a component and a sub-component.

4. The computer program product as in claim 1, wherein dimming comprises substantially reducing intensity for the remaining segments.

5. The computer program product as in claim 1, wherein the instructions are provided for overlay to a layout editor.

6. A computer program product stored on machine readable media and comprising machine executable instructions for incorporation into a layout editor for layout of a circuit design, the instructions for display of the layout of the circuit design, the product comprising instructions for:
receiving designation of at least one design segment comprising at least one of an area of interest, a layer, an element, a feature, a routine, a method, an object, a region, a component and a sub-component from a user;
receiving designation of a degree of intensity for at least one of highlighting and dimming a display of design segments; and
on a display screen, highlighting the designated design segments by increasing an intensity of an appearance of the designated design segment; and
dimming remaining segments on the display by substantially reducing intensity of the appearance of the remaining segments.

7. A system for editing a layout of a circuit, the system comprising:
processing, display, storage, input and output resources for executing machine readable instructions stored in the storage; and
a computer program product stored on the storage and comprising machine executable instructions for display of the layout, the product comprising instructions for
receiving designation of at least one design segment from a user;
receiving designation of a degree of intensity for at least one of highlighting and dimming the design segments; and
on a display screen, highlighting the designated design segments and dimming remaining segments on the display.
